(19) United States
(12) Patent Application Publication
(10) Pub. No.: US 2015/0073636 A1
(43) Pub. Date: Mar. 12, 2015

(54) NAVIGATION DEVICE AND NAVIGATION METHOD

(71) Applicant: Hiroshi Machino, Tokyo (JP)

(72) Inventor: Hiroshi Machino, Tokyo (JP)

(73) Assignee: Mitsubishi Electric Corporation, Tokyo (JP)

(21) Appl. No.: 14/389,264

(22) PCT Filed: Mar. 29, 2012
(86) PCT No.: PCT/JP2012/058371

§ 371 Date: Sep. 29, 2014

(51) Int. Cl. G01C 21/36

(52) U.S. Cl. CPC G01C 21/3605
USPC 701/22

(57) ABSTRACT

An object of the present invention is to provide a navigation device and a navigation method with which a site where an electric vehicle can be charged after arrival at the destination can be previously recognized before arriving at a destination. A navigation device used in the electric vehicle has a current position detector, an instruction input unit, and a route calculator. The current position detector acquires a current position. A destination is input by the instruction input unit. The route calculator searches for a route from the current position acquired by the current position detector, via the destination input by the instruction input unit, to a post-arrival chargeable site where a battery of the electric vehicle can be charged after arrival at the destination.

### TECHNICAL FIELD

The present invention relates to a navigation device and a navigation method which perform route guidance.

### BACKGROUND ART

Recently, for preserving the global environment by preventing environmental destruction and global warming, low-emission vehicles are spreading worldwide. Among others, development and sales have been encouraged especially for electric vehicles (abbreviated as EVs) which do not discharge exhaust gas.

Navigation devices used in vehicles including the electric vehicles have functions of searching for and displaying a route from the current position of the vehicle to a charging station equipped with a charging facility to enable charging of a battery installed in the vehicle (hereinafter, referred to as “in-vehicle battery”) at sites other than the user's house.

When an electric vehicle is to be used for, for example, driving a relatively long distance, the in-vehicle battery may need to be charged at the starting point, the destination, or between the starting point and the destination depending on the capacity of the in-vehicle battery or the like. For this reason, under the situation without sufficient charging facilities, the navigation devices are required to display exhaustion of battery capacity, perform guidance to a charging station, or the like while the vehicle is traveling.

Conventional techniques for such a navigation device are disclosed, for example, in Patent Documents 1 to 6.

Patent Document 1 discloses a navigation system for an electric vehicle which, when the remaining battery capacity becomes a certain level or less, calculates a distance the own vehicle is capable of traveling, and identifies a position of a charging station that is around the current position of the own vehicle according to the reachability.

Patent Document 2 discloses a charging station information providing apparatus which extracts a charging station that is around the current position of the electric vehicle from stored charging stations, and provides the position of the extracted charging station and availability information of chargers installed in the charging station.

Patent Document 3 discloses an in-vehicle navigation device which generates a charging station status icon indicative of charger usage in a charging station acquired via communication means, and displays the charging station status icon at the position of the charging station on an image of a map displaying the surroundings of the own vehicle position.

Patent Document 4 discloses a navigation device provided with a charging facility consideration key that narrows down searched out facilities to facilities provided with battery charging facilities.

Patent Document 5 discloses a vehicle navigation device which specifies charging stations having charging units which can charge a battery, informs an occupant of the charging stations, sets a charging station specified by the occupant as a destination, and searches out and displays a route to the charging station of destination.

Patent Document 6 discloses a navigation device that performs guidance to a charging facility in the vicinity of a specified destination or a specified transit point instead of guidance to the destination or the transit point.

### PRIOR ART DOCUMENTS

### Patent Documents

Patent Document 1: Japanese Patent Application Laid-Open No. 09-210702 (1997)
Patent Document 2: Japanese Patent Application Laid-Open No. 2003-262525
Patent Document 3: Japanese Patent Application Laid-Open No. 2011-164050
Patent Document 4: Japanese Patent Application Laid-Open No. 2010-286449
Patent Document 5: Japanese Patent Application Laid-Open No. 2011-203174
Patent Document 6: Japanese Patent Application Laid-Open No. 2011-237186

### SUMMARY OF INVENTION

### Problems to be Solved by the Invention

The above-described techniques disclosed in Patent Documents 1 to 6 have the following problems. The navigation system disclosed in Patent Document 1 merely identifies a position of a service station corresponding to a charging station for identification, and does not search for a route. Therefore, the navigation system cannot inform the user of a route to the charging station.

The charging station information providing apparatus disclosed in Patent Document 2 merely provides the position of the extracted charging station and the availability information of chargers installed in the charging station, and does not search for a route. Therefore, the charging station information providing apparatus cannot inform the user of a route to the charging station.

The in-vehicle navigation device disclosed in Patent Document 3 is configured to display information about a position and availability of a charging unit, so that it can inform the user of information as to whether or not the battery can be charged. However, the technique disclosed in Patent Document 3 is a technique of displaying the charging station status icon, and is not a technique of route search. Even with the technique disclosed in Patent Document 3, it is impossible to inform the user of information as to which route is the best route from the current position of the vehicle to a charging station where the battery can be charged.

As described above, the techniques disclosed in Patent Documents 1 to 3 cannot inform the user of a route to the charging station. Therefore, there may be disadvantages to the user such that the user cannot arrive at a desired charging station in the shortest time.

The navigation device disclosed in Patent Document 4 requires the user to instruct the navigation device to search for charging facilities for the purpose of narrowing the facilities down to a facility equipped with battery charging facilities, and to set the searched out charging facility as the destination. Therefore, operation is complicated.

The vehicle navigation device disclosed in Patent Document 5 requires the user to specify a charging station as the destination from among the informed charging stations. Therefore, operation is complicated.

The navigation device disclosed in Patent Document 6 does not search for a route to a charging facility corresponding to a charging station unless the user specifies a destination or a transit point, and therefore, operation is complicated. Moreover, unless the user sets the destination or the transit point again after being guided to the charging station, guidance to a destination or a transit point will not be performed.

The techniques disclosed in Patent Documents 1 to 6 do not take into account the remaining battery capacity required when traveling to a charging station after arrival at the destination. Therefore, the vehicle may be incapable of traveling after arrival at the destination.

An object of the present invention is to provide a navigation device and a navigation method with which a site where an electric vehicle can be charged after arrival at the destination can be previously recognized before arriving at a destination.

### Means for Solving the Problems

A navigation device according to the present invention is a navigation device used in an electric vehicle, the device including: a Central Processing Unit; a memory having stored therein instructions which, when executed by the Central Processing Unit, cause the Central Processing Unit to carry out steps of: acquiring a current position; receiving, as an input, a destination; and searching for a route from the acquired current position, via the destination inputted, to a post-arrival chargeable site where a battery of the electric vehicle is capable of being charged after arrival at the destination.

A navigation method according to the present invention includes: acquiring a current position of an electric vehicle; and searching for a route from the acquired current position, via a destination, to a post-arrival chargeable site where a battery of the electric vehicle is capable of being charged after arrival at the destination.

### Effects of the Invention

With the navigation device according to the present invention, the navigation device is used in an electric vehicle, and the device includes: a Central Processing Unit; a memory having stored therein instructions which, when executed by the Central Processing Unit, cause the Central Processing Unit carry out steps of: acquiring a current position; receiving, as an input, a destination; and searching for a route from the acquired current position, via the destination inputted, to a post-arrival chargeable site. As a result, post-arrival chargeable site can be previously recognized before arriving at the destination. Therefore, measures can be previously taken, for example, to prevent the electric vehicle from being incapable of traveling after arrival at the destination.

The navigation method according to the present invention acquires a current position of an electric vehicle, and searches for a route from the acquired current position, via a destination, to a post-arrival chargeable site. As a result, the post-arrival chargeable site can be previously recognized before arriving at the destination. Therefore, measures can be previously taken, for example, to prevent the electric vehicle from being incapable of traveling after arrival at the destination.

The object, features, aspects, and advantages of the present invention will become more apparent from the following detailed description and the accompanying drawings.

### BRIEF DESCRIPTION OF DRAWINGS

FIG. 1 is a block diagram illustrating a configuration of a navigation device 100 according to a first embodiment of the present invention.

FIG. 2 is a diagram illustrating a current position screen 200.

FIG. 3 is a diagram illustrating a menu screen 210.

FIG. 4 is a diagram illustrating a facility type screen 220.

FIG. 5 is a diagram illustrating a facility list screen 230.

FIG. 6 is a diagram illustrating a facility surroundings screen 240.

FIG. 7 is a diagram illustrating a whole route screen 250.

FIG. 8 is a flowchart showing a route guidance procedure in an underlying technology of the present invention.

FIG. 9 is a flowchart showing the route guidance procedure in the underlying technology of the present invention.

FIG. 10 is a diagram illustrating a whole route screen 300.

FIG. 11 is a diagram illustrating a whole route screen 310.

FIG. 12 is a flowchart showing a route guidance procedure in the first embodiment of the present invention.

FIG. 13 is a flowchart showing the route guidance procedure in the first embodiment of the present invention.

FIG. 14 is a flowchart showing the route guidance procedure in the first embodiment of the present invention.

FIG. 15 is a flowchart showing the route guidance procedure in the first embodiment of the present invention.

FIG. 16 is a flowchart showing the route guidance procedure in the first embodiment of the present invention.

FIG. 17 is a flowchart showing the route guidance procedure in the first embodiment of the present invention.

FIG. 18 is a flowchart showing a route guidance procedure in a second embodiment of the present invention.

FIG. 19 is a flowchart showing the route guidance procedure in the second embodiment of the present invention.

FIG. 20 is a flowchart showing the route guidance procedure in the second embodiment of the present invention.

FIG. 21 is a flowchart showing the route guidance procedure in the second embodiment of the present invention.

FIG. 22 is a flowchart showing the route guidance procedure in the second embodiment of the present invention.

### DESCRIPTION OF EMBODIMENTS

### First Embodiment

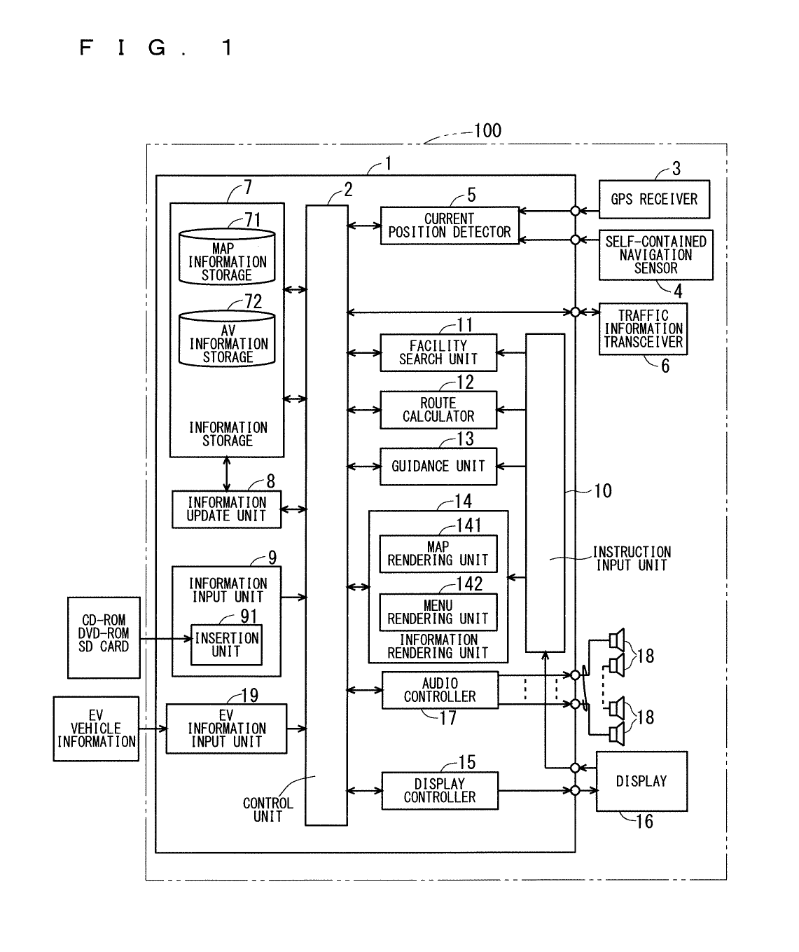

FIG. 1 is a block diagram illustrating a configuration of a navigation device 100 according to the first embodiment of the present invention. The navigation device 100 is used in a vehicle, and is used as an in-vehicle navigation device. In this embodiment, the navigation device 100 is an in-vehicle navigation composite device which has a navigation function of performing route guidance and an Audio Visual (abbreviated as: AV) function of performing reproduction or the like of audio and video.

Specifically, the navigation device 100 is used in an electric vehicle (EV). Here, the “electric vehicle” may be a vehicle which is solely powered by electric energy or a hybrid vehicle which is powered by electric energy and another type of energy. For example, the electric vehicle may be a plug-in hybrid vehicle which can be charged by supplying electric power from an external electric power source such as a home wall socket. Hereinafter, a vehicle equipped with the navigation device 100 will be referred to as “own vehicle”.

The navigation device 100 includes a navigation device body 1, a Global Positioning System (abbreviated as GPS) receiver 3, a self-contained navigation sensor 4, a traffic information transceiver 6, a display 16, and a speaker 18. The display 16 and the speaker 18 carry out the step of outputting the searched out route.

The navigation device body 1 includes a control unit 2, a current position detector 5, an information storage 7, an information update unit 8, an information input unit 9, an instruction input unit 10, a facility search unit 11, a route calculator 12, a guidance unit 13, an information rendering unit 14, a display controller 15, an audio controller 17, and an EV information input unit 19.

The control unit 2 carries out the step of judging whether traveling from the current position via the destination to the post-arrival chargeable site, based on the battery charging information. The current position detector 5 carries out the step of acquiring a current position. The instruction input unit 10 carries out the step of receiving, as an input, a destination. The route calculator 12 carries out the step of searching for a route from the acquired current position, via the destination inputted, to a post-arrival chargeable site where a battery of the EV is capable of being charged after arrival at the destination. The guidance unit 13 carries out the step of guiding the route searched out by the route calculator 12. The EV information input unit 19 carries out the step of acquiring a battery charging information about charged amount of the battery of the EV.

The control unit 2 is implemented by a Central Processing Unit (abbreviated as CPU). The control unit 2 has a built-in memory (not shown). According to a control program stored in the memory, the control unit 2 integrally controls the current position detector 5, the information storage 7, the information update unit 8, the facility search unit 11, the route calculator 12, the guidance unit 13, the information rendering unit 14, the display controller 15, and the audio controller 17, which are included in the navigation device body 1.

The GPS receiver 3 receives radio signals transmitted from GPS satellites. The GPS receiver 3 provides the received radio signals to the current position detector 5. The radio signals provided to the current position detector 5 are used when a satellite navigation system is applied to measurement of the current position of the own vehicle.

The self-contained navigation sensor 4 includes a direction sensor that detects a direction of the own vehicle and a traveled distance sensor that detects a traveled distance by detecting the number of revolutions of the wheels of the own vehicle. The self-contained navigation sensor 4 provides information indicating the direction detected by the direction sensor (hereinafter, referred to as “direction information”) and information indicating the traveled distance detected by the traveled distance sensor (hereinafter, referred to as “traveled distance information”) for the current position detector 5. The direction information and the traveled distance information provided to the current position detector 5 are used when a self-contained navigation system is applied to detection of the current position and the direction of the own vehicle.

Based on the radio signals provided from the GPS receiver 3 and the direction information and the traveled distance information provided from the self-contained navigation sensor 4, the current position detector 5 detects the current position and the direction of travel of the own vehicle by using the satellite navigation system in combination with the self-contained navigation system, and carrying out map matching based on map information.

Here, “map matching” is one method of estimating the most probable position of the own vehicle as the current position of the own vehicle by taking into account road information included in the map information, a travel path of the own vehicle including right turn and left turn, and the like, and comparing these with the detected current position of the own vehicle. In this embodiment, although a case will be described where a hybrid method of using the satellite navigation system in combination with the self-contained navigation system is adopted, a case where only one of the navigation systems is adopted is also possible.

The traffic information transceiver 6 transmits and receives traffic information to and from the control unit 2. Specifically, the traffic information transceiver 6 receives or transmits the traffic information successively or at predetermined timing. The traffic information transceiver 6 receives traffic information provided from, for example, Vehicle Information and Communication System (abbreviated as VICS (registered trademark)) by FM multiplex broadcasting, radio wave beacon, or light beacon. The traffic information includes information of congestion state, congestion distance, traffic regulation, and the time required for travel for each road.

The traffic information transceiver 6 is capable of performing communication by using DSRC (Dedicated Short Range Communication). DSRC is a short-range radio technology using radio wave of 5.8 GHz band. Various services can be provided for the user by using DSRC in bi-directional communication or one-way communication between a road side device and an in-vehicle device, i.e., the navigation device 100.

Cases where the traffic information transceiver 6 functions as a transmitter for transmitting the traffic information include a case where the traffic information transceiver 6 transmits information about the own vehicle, for example, the current position, the traveling speed, and other information called probe information. In the case where the traffic information is not bi-directionally exchanged, the traffic information transceiver 6 may be replaced with a traffic information receiver.

The information storage 7 is implemented by a Hard Disk Drive (abbreviated as HDD) device. The information storage 7 stores information required for various functions including the navigation function and an entertainment function.

The information storage 7 previously includes a map information storage 71 and an AV information storage 72. The map information storage 71 stores map information representing a map. The AV information storage 72 stores AV information, specifically, information of audio or video, or both of audio and video. The navigation device 100 according to this embodiment is a standalone navigation device which operates based on the map information stored in the map information storage 71.

The map information storage 71 has a plurality of hierarchically organized maps corresponding to predetermined scales as the map information. The map information includes map display information. The map display information includes at least one of “road information” about roads, “facility information” representing types, names, and positions of facilities, “types of character information” representing the names of places, the names of facilities, the names of intersections, and the names of roads, and “types of icon information” representing facilities, route numbers, and the like. The map display information is displayed on the display 16.

The map information storage 71 also stores other information such as guidance information to be used by the guidance unit 13 and information not displayed on the display 16. The guidance information includes position information of a predetermined key point, and rendering information and audio guidance information of the predetermined key point. The information not displayed on the display 16 includes, for example, information representing a road with line segments called links and points called nodes, and information about a link cost as a load required to travel the link. The information not displayed on the display 16 is not limited thereto, and may include other various kinds of information.

The map information and the AV information stored in the information storage 7 can be changed, and can be partly updated, partly added, partly deleted, completely deleted, or completely updated by the information update unit 8 based on an instruction from the control unit 2.

The information update unit 8 updates information including the map information and the AV information stored in the information storage 7 based on an instruction from the control unit 2.

Information such as the map information and the AV information is input into the information input unit 9 from outside of the navigation device 100. The information provided to the information input unit 9 from outside of the navigation device 100 is used when the information stored in the information storage 7 is updated.

The information input unit 9 has an insertion unit 91 to which and from which a medium can be inserted and removed. The medium stores information such as the map information and the AV information. The medium includes, for example, a disk medium such as a CD-ROM (Compact Disc Read Only Memory) and a DVD-ROM (Digital Versatile Disk Read Only Memory) and a semiconductor medium such as an SD (Secure Digital) card. The control unit 2 reads out the above-described information of the map information or the AV information from the medium inserted in the insertion unit 91. The information such as the map information or the AV information read out from the medium that is inserted in the insertion unit 91 is stored in the information storage 7.

The instruction input unit 10 includes, for example, a hardware operation switch operated by a user, a touch switch set and displayed on the display 16 described below, a remote controller mounted to a steering wheel of the own vehicle or the like, and a voice recognition device having a voice recognition function of recognizing a user's voice instruction.

The instruction input unit 10 is used by the user in inputting information such as numerical information, character information, and instruction information for the navigation device body 1. When the instruction input unit 10 is operated by the user, the instruction input unit 10 generates an instruction signal indicating an instruction corresponding to the operation made by the user, and provides the instruction signal to at least any one of the facility search unit 11, the route calculator 12, the guidance unit 13, and the information rendering unit 14.

The facility search unit 11, the route calculator 12, the guidance unit 13, and the information rendering unit 14 provide the control unit 2 with the instruction signal provided from the instruction input unit 10. Therefore, the user of the navigation device 100 can operate the instruction input unit 10 to provide an instruction corresponding to the operation to the facility search unit 11, the route calculator 12, the guidance unit 13, the information rendering unit 14, and the control unit 2.

The facility search unit 11 searches facility information stored in the map information storage 71 for a desired facility. Specifically, the facility search unit 11 searches the map information stored in the map information storage 71 for a facility, a place, and the like desired by the user based on the user's instruction provided from the instruction input unit 10. The result searched out by the facility search unit 11 is provided to the display 16 via the control unit 2 and the display controller 15, and is displayed on the display 16.

The route calculator 12 calculates a route preferable to take the user to the desired site. Specifically, the route calculator 12 calculates the best route from the current position of the own vehicle to a site such as a destination and a transit point set by the user (hereinafter, referred to as “recommended route”) based on the instruction signal provided from the instruction input unit 10. The recommended route means, for example, a route which is the shortest (hereinafter, referred to as “shortest route”), a route which takes the shortest time (hereinafter, referred to as “fastest route”), a route with lowest cost including a toll for a toll road (hereinafter, referred to as “low-cost route”), a route which consumes the lowest power (hereinafter, referred to as “low-power consumption route”), or a route with a favorable balance between time and cost (hereinafter, referred to as “standard route”). The recommended route may be optionally arranged from the above-described routes.

The route calculator 12 acquires the current position of the own vehicle from the current position detector 5 via the control unit 2. Further, the route calculator 12 calculates the recommended route based on site information input from the instruction input unit 10 and the map information acquired from the map information storage 71. The recommended route calculated by the route calculator 12 is provided to the display 16 via the control unit 2 and the display controller 15, and is displayed on the display 16.

When the route calculation is performed by the route calculator 12, for example, the publicly known Dijkstra's Algorithm or the like is used which accumulates link costs allocated to the links which represent respective roads by line segments and figures out a route requiring the minimum link cost.

The guidance unit 13 assists the user in driving at a predetermined key point by providing the guidance information to the control unit 2 based on the instruction signal provided from the instruction input unit 10. For example, while traveling the recommended route, the guidance unit 13 provides the guidance information indicating a site such as an intersection or crossroads at which the direction has to be changed, or a site which is likely to be mistaken. Further, when traveling a multi-lane road, the guidance unit 13 takes account of right turn or left turn ahead, and provides the guidance information indicating a site to guide the user to previously change the lane to a predetermined lane.

The guidance unit 13 acquires the current position of the own vehicle from the current position detector 5 via the control unit 2. Also, the guidance unit 13 acquires the recommended route from the route calculator 12 via the control unit 2. Further, the guidance unit 13 acquires the guidance information included in the map information from the map information storage 71 via the control unit 2.

When the own vehicle has arrived at a predetermined key point such as an intersection, the guidance unit 13 instructs the display controller 15 via the control unit 2 to visually present, for example, a direction to take at the intersection by means of an arrow or color painting of the road, and to output to the display 16 an enlarged guide map which is enlarged or enlarged and transformed. Alternatively, the guidance unit 13 instructs the display controller 15 via the control unit 2 to visually present a direction to take, and to output the actual image of the key point or an image similar to that to the display 16.

The information rendering unit 14 performs information processing for rendering, on the display 16, various types of information desired by the user such as the map information and the guidance information. Further, the information rendering unit 14 performs information processing for rendering, on the display 16, a setting of respective functions of the navigation device 100 as a menu screen.

The information rendering unit 14 has a map rendering unit 141 and a menu rendering unit 142. The map rendering unit 141 performs information processing for rendering a desired map on the display 16 by processing the map information stored in the map information storage 71 based on the instruction signal provided from the instruction input unit 10. The menu rendering unit 142 manages the state of the menu screen and performs information processing for rendering the menu screen on the display 16 based on the instruction signal provided from the instruction input unit 10.

The map rendering unit 141 acquires necessary information from the map information storage 71, the current position detector 5, the facility search unit 11, the route calculator 12, the guidance unit 13, and the menu rendering unit 142, and processes information to be displayed on the display 16 based on the instruction provided from the instruction input unit 10. The map rendering unit 141 provides the rendering information about the map to be rendered on the display 16 for the display controller 15 via the control unit 2.

The menu rendering unit 142 provides the rendering information about the menu screen to be rendered on the display 16 to the display controller 15 via the control unit 2 based on the instruction provided from the instruction input unit 10. A rendering of the menu screen includes a setting of a touch switch which is set on a display screen of the display 16. When the user operates the touch switch, the operation is recognized by the instruction input unit 10.

The display controller 15 converts the rendering information provided from the information rendering unit 14 via the control unit 2 into video signals available for the display 16, and instructs the display 16 to display an image represented by the rendering information according to a control command provided from the control unit 2. Further, the display controller 15 can instruct to render image information stored in the AV information storage 72 on the display 16.

The display 16 is implemented by a liquid crystal display, for example. The display 16 displays the image represented by the rendering information on the display screen based on the instruction provided from the display controller 15.

In response to input of information about audio such as the AV information (hereinafter, referred to as “audio data”), the audio controller 17 causes the audio to be output from the speaker 18 connected to the navigation device body 1. Specifically, the audio controller 17 converts the audio data provided from the control unit 2 into audio signals available for the speaker 18, and provides the audio signals to the speaker 18 based on a control command provided from the control unit 2. As a result, the audio is output from the speaker 18.

When the audio controller 17 receives input of the guidance information from the guidance unit 13 via the control unit 2, the audio controller 17 becomes able to instruct the speaker 18 to output the input guidance information as audio. Specifically, in response to input of the audio data as the guidance information, the audio controller 17 converts the input audio data into the audio signals available for the speaker 18, and provides the audio signals to the speaker 18. As a result, the guidance information is output from the speaker 18 as audio.

The speaker 18 outputs the audio represented by the audio signals provided from the audio controller 17. A plurality of speakers 18 are provided. In the case where the input audio data is the guidance information, the audio controller 17 controls the speakers 18 to output the guidance information from the speaker near to the driver's seat among the plurality of speakers 18.

The plurality of speakers 18 may have the same structure or different structures. For example, the plurality of speakers with different structures may have different roles such as a structure of primarily outputting a high-pitched tone, a structure of primarily outputting a medium-pitched tone, and a structure of primarily outputting a low-pitched tone may take respective roles. The speaker 18 to be used for outputting the guidance information may desirably have the structure of primarily outputting a medium-pitched tone in consideration of audibleness.

The audio controller 17 distributes the audio information acquired from the AV information storage 72 or the information input unit 9 among the respective speakers 18 in suitable allotments, and instructs the respective speakers 18 to output the audio information. In the case where the information acquired from the AV information storage 72 or the information input unit 9 includes both the audio information and the video information of television broadcasting, a DVD, or the like, the audio controller 17 provides the acquired audio information to the speaker 18 and instructs the speaker 18 to output the audio information, and the display controller 15 provides the acquired video information to the display 16 and instructs the display 16 to output the video information. In this manner, the audio controller 17 and the display controller 15 operate in conjunction with each other to implement the entertainment function.

The EV information input unit 19 supplies, to the navigation device 100, information about the EV such as EV traveling information and battery charging information (hereinafter, referred to as “EV information”). By receiving the EV information of EV vehicle information from outside, the EV information input unit 19 can update the control unit 2 with the EV information. Further, by receiving information from outside, the EV information input unit 19 itself can also function as the information storage 7. Herein, the information received by the EV information input unit 19 from outside is specifically EV model information and battery charging state information.

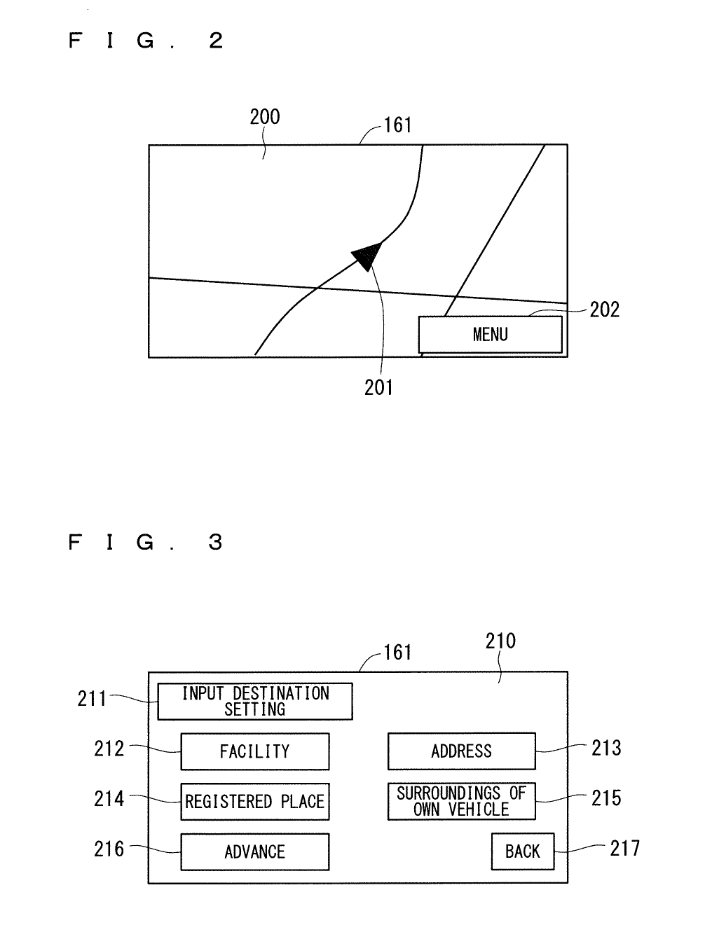

FIGS. 2 to 7 are diagrams illustrating display screens 161 on the display 16 of the navigation device 100 in route guidance processing in an underlying technology as a premise of the present invention. In response to the user's input of an instruction to change the display of the display screen 161 (hereinafter, referred to as “change instruction”) from the instruction input unit 10, the information rendering unit 14 performs processing according to the input change instruction, and the instruction signal is provided to the display 16 via the control unit 2 and the display controller 15. In this embodiment, inputting of an instruction to the instruction input unit 10 is exemplified by user operation on the touch switches on the display screen 161.

FIG. 2 is a diagram illustrating a current position screen 200. In response to selection of displaying a map covering the current position of the own vehicle and its surroundings as an object of displaying the map, the current position screen 200 illustrated in FIG. 2 is displayed. In the current position screen 200, a map covering a range of about one kilometer square from the own vehicle is displayed, for example.

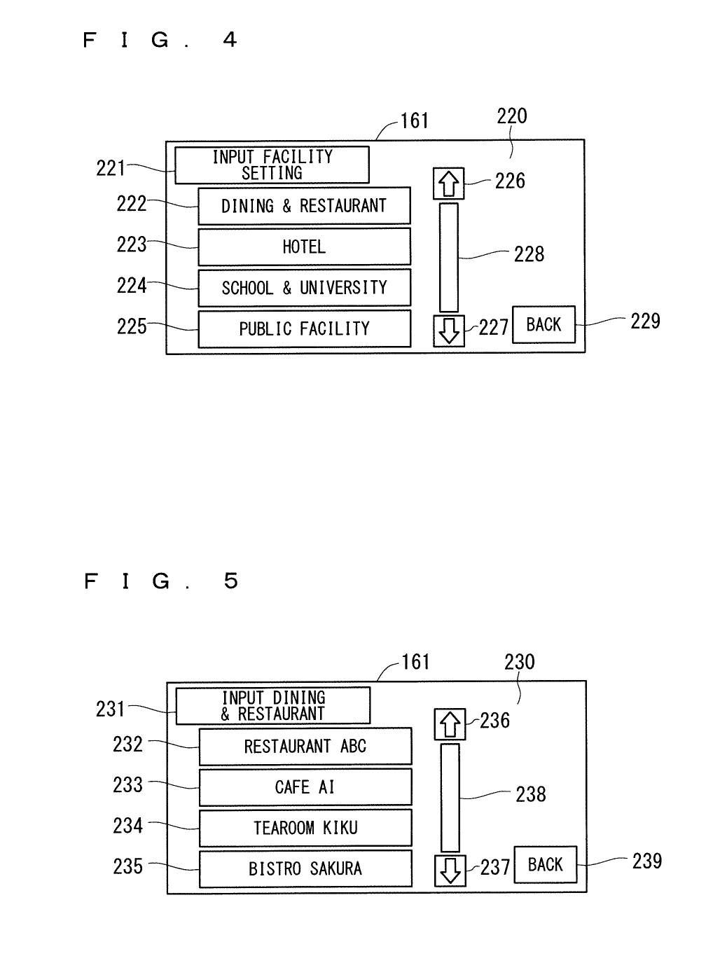

The current position of the own vehicle to be displayed in the current position screen 200 is detected by the current position detector 5 based on the information provided from the GPS receiver 3, the self-contained navigation sensor 4, and the like. In the current position screen 200, the current position of the own vehicle is indicated by a current position symbol 201. It is considered that a map covering the current position of the own vehicle and its surroundings to be displayed in the current position screen 200 will be most frequently displayed during the use of the navigation device 100. In FIG. 2, a menu button 202 at the lower right of the current position screen 200 is a touch switch which has been set in the display screen 161 of the display 16. In response to user's pressing on the menu button 202, the current position screen 200 displaying the map covering the current position and the area around the current position illustrated in FIG. 2 transitions to a menu screen 210 for selecting a function illustrated in FIG. 3.

FIG. 3 is a diagram illustrating the menu screen 210. In the menu screen 210, “input destination setting” is displayed in a title bar 211. In the example illustrated in FIG. 3, the menu screen 210 includes three selection buttons 212, 213, and 215 as touch switches for performing three functions of “facility search”, “surrounding facility search”, and “address search”. In response to pressing on the selection button 212 described as “facility” (hereinafter, referred to as “‘facility search’ button”), “facility search” is performed. In response to pressing on the selection button 215 described as “surroundings of own vehicle”, “surrounding facility search” is performed. In response to pressing on the selection button 213 described as “address”, “address search” is performed.

Further, the menu screen 210 includes the selection button 214 described as “registered place” as a touch switch for performing a function of “registered place search” which searches for a destination from among previously registered places and sets the place as the destination. Further, the menu screen 210 includes the selection button 216 described as “advance” as a touch switch for performing a function other than “facility search”, “surrounding facility search”, “address search”, and “registered place search”.

Further, the menu screen 210 includes a back button 217 described as “back” as a touch switch for moving back to the current position screen 200 illustrated in FIG. 2. The menu screen 210 is not limited to the example illustrated in FIG. 3, and may include other touch switches such as selection buttons for displaying maps covering surroundings of the destination, surroundings of a transit point, or surroundings of the user's house.

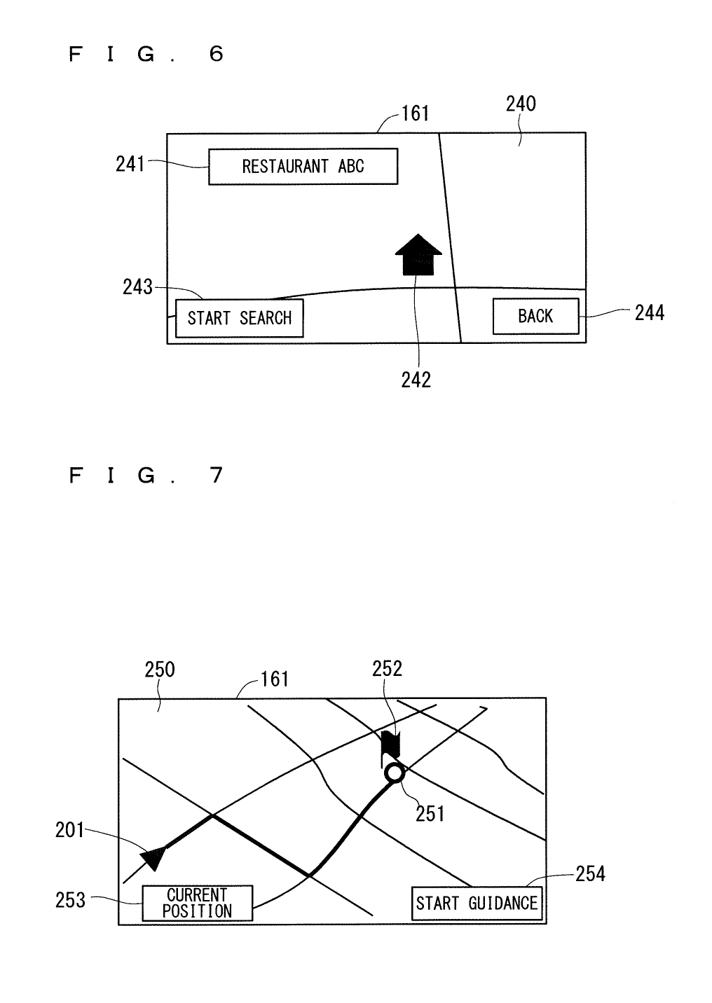

FIG. 4 is a diagram illustrating a facility type screen 220. The facility type screen 220 is a screen displaying a result of a facility search performed in response to pressing on the “facility search” button 212 in the menu screen 210 illustrated in FIG. 3. In the facility type screen 220, “input facility setting” is displayed in a title bar 221. The facility type screen 220 includes four selection buttons 222 to 225 as touch switches for displaying a list for each facility type.

Further, the facility type screen 220 includes a scroll bar 228. By pressing an up button 226 or a down button 227 on the scroll bar 228, the user can vertically move a range of selection buttons displayed in the facility type screen 220 so that other selection buttons are displayed. The up button 226 and the down button 227 are touch switches. Further, the facility type screen 220 includes a back button 229 described as “back” as a touch switch for moving back to a previous screen, i.e., the menu screen 210 illustrated in FIG. 3.

As a facility search method, for example, there is known a method of refining a search with a facility type and a geographical position as conditions, by using the facility information stored in the map information storage 71, according to the user's instruction provided from the instruction input unit 10. The facility search method is not limited thereto, and various methods can be used.

The facility search is performed by the facility search unit 11. From among the facilities detected by the facility search, a desired facility is selected by the user and set as the destination according to the user's instruction. In this case, a recommended route from the current position of the own vehicle to the desired facility is calculated by the route calculator 12, and guidance required at a predetermined key point in the recommended route is calculated by the guidance unit 13.

Together with the current position of the own vehicle acquired by the current position detector 5, the above-described calculation results are provided to the information rendering unit 14, and when the own vehicle has arrived at the predetermined key point, the guidance information is displayed in or replaces the map displayed in the display screen 161 as required. Further, the navigation device 100 also performs audio guidance by part of the speakers 18 at the predetermined key point via the audio controller 17 based on the guidance information provided from the guidance unit 13.

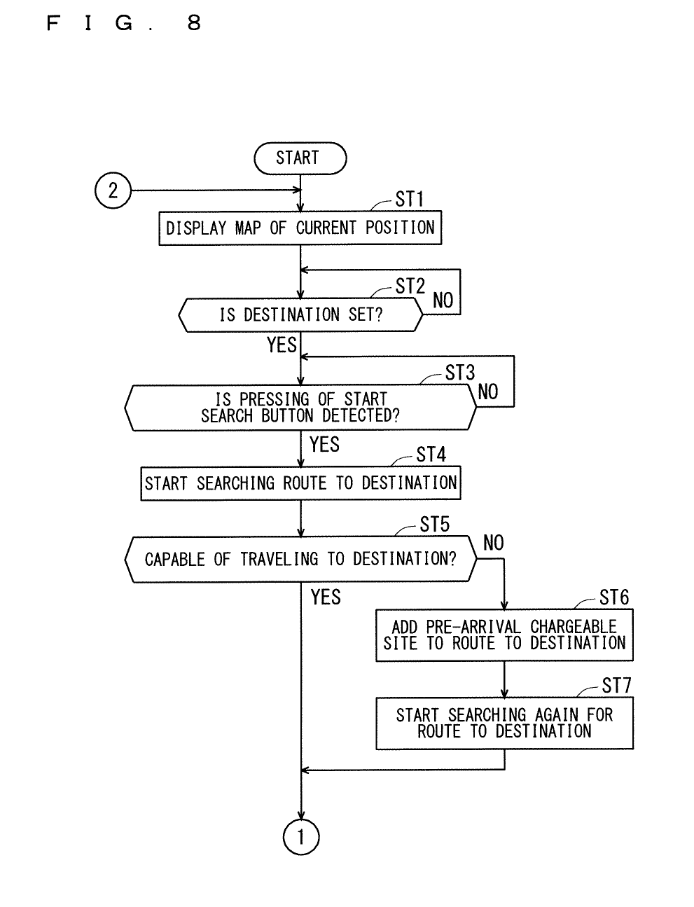

FIG. 5 is a diagram illustrating a facility list screen 230. As an example of the facility list screen 230, FIG. 5 illustrates a screen displaying a result of a search for facilities classified as “dining & restaurant” in response to pressing on a selection button 222 described as “dining & restaurant” in the facility type screen 220 illustrated in FIG. 4. In the facility list screen 230 illustrated in FIG. 5, “input dining & restaurant” is displayed in a title bar 231. The facility list screen 230 includes four selection buttons 232 to 235 as touch switches for setting an individual facility as the destination.

Further, the facility list screen 230 includes a scroll bar 238. By pressing an up button 236 or a down button 237 on the scroll bar 238, the user can vertically move a range of selection buttons displayed in the facility list screen 230 so that other selection buttons are displayed. The up button 236 and the down button 237 are touch switches. Further, the facility list screen 230 includes a back button 239 described as “back” as a touch switch for moving back to a previous screen, i.e., the facility type screen 220 illustrated in FIG. 4.

FIG. 6 is a diagram illustrating a facility surroundings screen 240. As an example of the facility surroundings screen 240, FIG. 6 illustrates a case where “restaurant ABC” is set as the destination in response to pressing on a selection button 232 described as “restaurant ABC” in the facility list screen 230 illustrated in FIG. 5. In the facility surroundings screen 240, the name of the facility set as the destination is displayed in a title bar 241. In the example illustrated in FIG. 6, “restaurant ABC” is displayed.

In the facility surroundings screen 240, the facility which is set as the destination (hereinafter, referred to as “destination facility”) is represented by a house symbol denoted by the reference character “242”. In the facility surroundings screen 240, a map covering the destination facility 242 and the surroundings thereof is displayed. The facility surroundings screen 240 includes a start search button 243 described as “start search” as a touch switch for inputting an instruction to start searching for a route from the current position of the own vehicle to the destination. Further, the facility surroundings screen 240 includes a back button 244 described as “back” as a touch switch for moving back to a previous screen, i.e., the facility list screen 230 illustrated in FIG. 5.

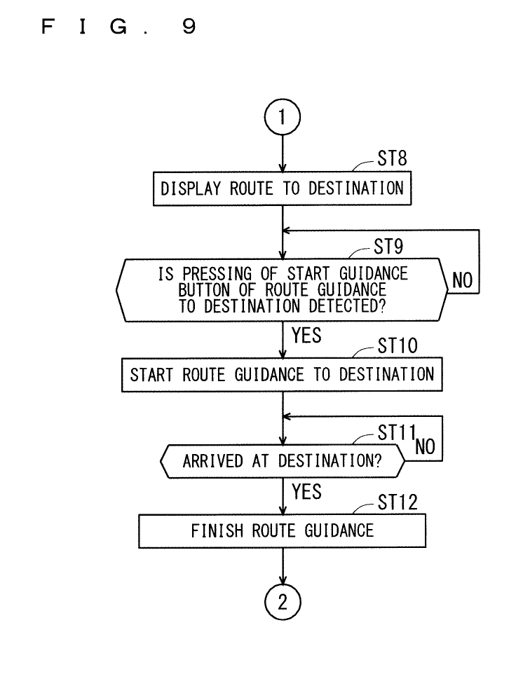

FIG. 7 is a diagram illustrating a whole route screen 250. The whole route screen 250 is a screen displaying a result of a search for a route from the current position of the own vehicle to the destination in response to pressing on the start search button 243 in the facility surroundings screen 240 illustrated in FIG. 6. In the whole route screen 250, the current position of the own vehicle is represented by the current position symbol 201, and the destination is represented by a white circle denoted by the reference character “251”. Further, at the position of the destination 251, a flag symbol is displayed as a destination symbol 252 indicating the destination 251.

The whole route screen 250 displays the current position symbol 201 of the own vehicle and the destination 251, a map covering the surroundings thereof, and a route from the current position symbol 201 of the own vehicle to the destination 251. The route is shown by a thick line. Further, the whole route screen 250 includes a current position button 253 described as “current position” as a touch switch for displaying the current position screen 200 illustrated in FIG. 2. Also, the whole route screen 250 includes a start guidance button 254 described as “start guidance” as a touch switch for inputting an instruction to start guidance to the destination 251.

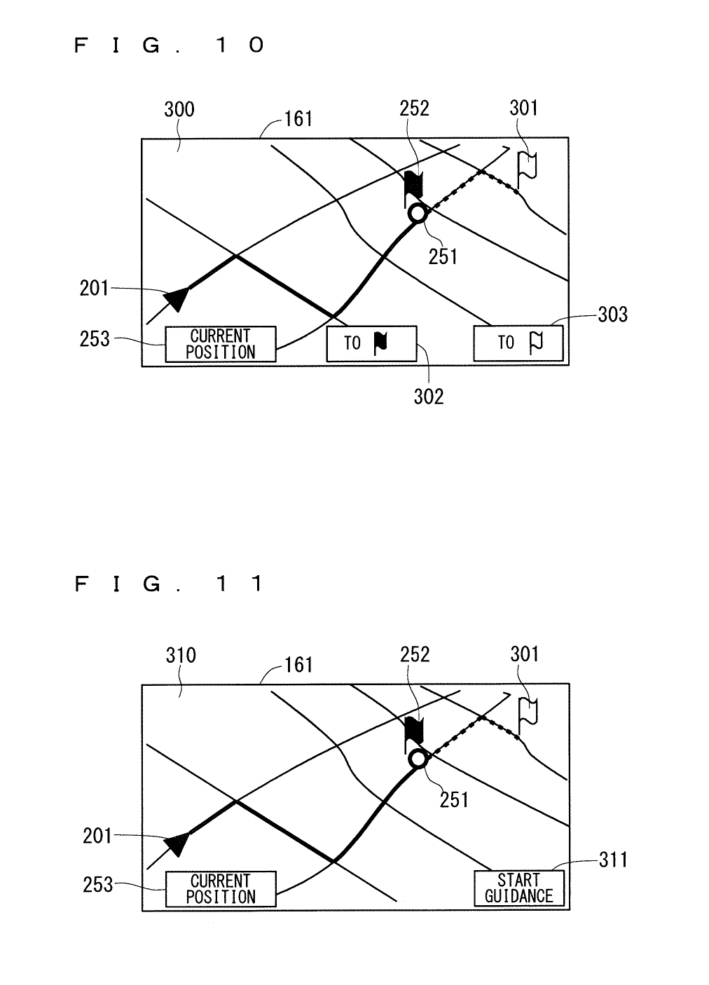

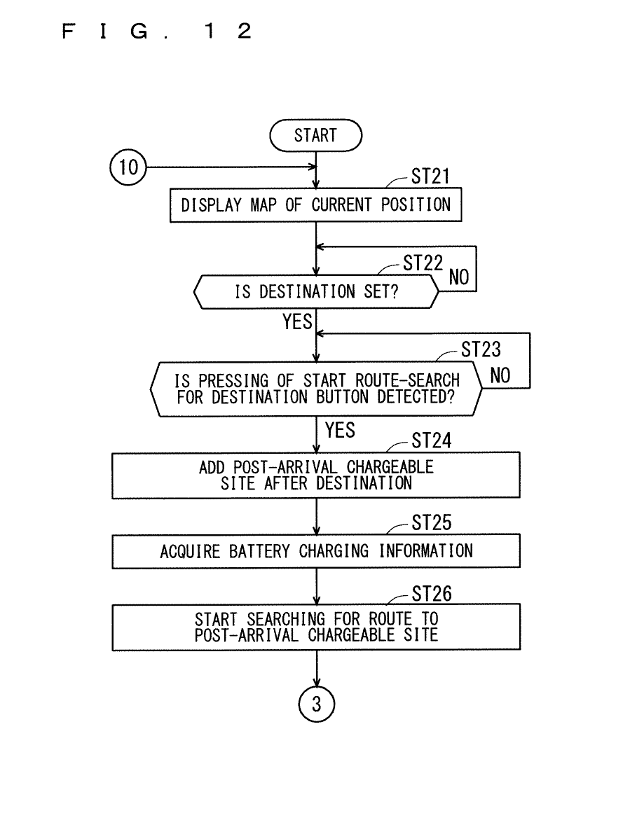

FIGS. 8 and 9 are flowcharts showing a route guidance procedure of the underlying technology as a premise of the present invention. Each process of the flowcharts shown in FIGS. 8 and 9 is performed by the control unit 2. Processing in the flowcharts shown in FIGS. 8 and 9 is started in response to power-on of the navigation device 100, and the operation proceeds to step ST1.

In step ST1, the control unit 2 causes a map covering the current position to be displayed on the display 16. For example, the control unit 2 causes the above-described current position screen 200 illustrated in FIG. 2 to be displayed in the display screen 161 on the display 16 as the map covering the current position.

Specifically, firstly, current position data representing the current position of the own vehicle and map data are acquired. That is, the current position detector 5 acquires the current position data from the GPS receiver 3 and the self-contained navigation sensor 4, and provides the detected current position of the own vehicle to the control unit 2. Meanwhile, the information input unit 9 reads out the map data from an HDD constituting the information input unit 9 or a medium such as a DVD inserted in the insertion unit 91 of the information input unit 9. The information input unit 9 stores the read out map data in the map information storage 71 via the control unit 2.

The control unit 2 reads out the map data from the map information storage 71, and performs matching processing for superimposing the current position symbol 201 representing the position of the own vehicle (hereinafter, referred to as “own vehicle position”) on a position corresponding to the current position data provided from the current position detector 5. The map data which has been subjected to the matching processing is provided to the display controller 15 via the control unit 2.

The display controller 15 generates rendering data based on the map data subjected to the matching processing by the control unit 2, and provides the rendering data to the display 16. Consequently, as illustrated in FIG. 2 described above, the map covering the area around the current position of the own vehicle is displayed on the display 16. When the map covering the current position is displayed, the operation proceeds to step ST2.

In step ST2, the control unit 2 judges whether or not the destination is set. In step ST2, if it is judged that the destination is set, the operation proceeds to step ST3, and if it is judged that the destination is not set, the control unit 2 waits until the destination is set.

The user inputs the destination such as a site and a facility included in the map data from the instruction input unit 10 by operating, for example, a touch switch as destination input means displayed on the display 16, an input button provided to the body, or the like. For example, the user inputs the destination by pressing the above-described touch switches displayed in the display screens 161 illustrated in FIGS. 3 to 5.

If it is judged that the destination is set in step ST2, the facility search unit 11 provides the control unit 2 with destination input data of a site, a facility, and the like based on the information input from the instruction input unit 10. The control unit 2 provides the route calculator 12 and the guidance unit 13 with the result of the matching processing performed on the map and the current position of the own vehicle as well as the destination input data provided from the facility search unit 11.

Next, in step ST3, the control unit 2 judges whether or not pressing on the start search button 243 is detected in the above-described facility surroundings screen 240 illustrated in FIG. 6. In step ST3, if it is judged that the pressing is detected, the operation proceeds to step ST4, and if it is judged that the pressing is not detected, the control unit 2 waits until the pressing is detected.

In step ST4, the control unit 2 starts a route search. Specifically, the route calculator 12 creates a route by performing processes for searching for a route from the current position of the own vehicle to the destination. When the route has been created in this manner, the operation proceeds to step ST5.

In step ST5, the control unit 2 judges whether or not the own vehicle can travel to the destination. In step ST5, if it is judged that the own vehicle can travel to the destination, the operation proceeds to step ST8, and if it is judged that the own vehicle cannot travel to the destination, the operation proceeds to step ST6.

In step ST6, the control unit 2 adds, to the route to the destination, a pre-arrival chargeable site which is a battery chargeable site available for battery charging before arriving at the destination, and the operation proceeds to step ST7.

In step ST7, the control unit 2 starts searching again for a route to the destination to include the pre-arrival chargeable site added in step ST6. Specifically, the route calculator 12 creates a route by again performing processes for searching for a route from the current position of the own vehicle to the destination. When the route has been created in this manner, the operation proceeds to step ST8.

In step ST8, the control unit 2 displays the route to the destination. Specifically, the control unit 2 instructs the guidance unit 13 to perform route guidance processing from the own vehicle position to the destination. The guidance unit 13 creates route guidance information by performing the guidance processing from the own vehicle position to the destination based on the instruction from the control unit 2. The control unit 2 provides the display controller 15 with the guidance information including the route to the destination provided from the route calculator 12 and an intersection guide map to the destination and the like provided from the guidance unit 13. The display controller 15 performs display processing on the provided route and guidance information for displaying on the display 16, and provides the information to the display 16. As a result, the route and the guidance information are displayed on the display 16.

In step ST9, the control unit 2 judges whether or not pressing on the start guidance button for instructing to start route guidance to the destination is detected. In step ST9, if it is judged that the pressing is detected, the operation proceeds to step ST10, and if it is judged that the pressing is not detected, the control unit 2 waits until the pressing is detected.

In step ST10, the control unit 2 starts route guidance to the destination. Specifically, the control unit 2 provides the audio controller 17 with guidance audio information out of the guidance information to the destination provided from the guidance unit 13. The audio controller 17 performs audio processing on the provided guidance audio information for outputting from the speaker 18, and provides the guidance audio information to the speaker 18. As a result, the audio represented by the guidance audio information is output from the speaker 18. In this manner, the user is guided through the route by audio output from the speaker 18.

Thereafter, the control unit 2 sequentially provides the audio controller 17 with the guidance audio information representing guide messages corresponding to the environment which changes as the vehicle travels, and causes the speaker 18 to output the guide messages. As a result, the guide messages corresponding to the environment which changes as the vehicle travels are sequentially output from the speaker 18. When the route guidance has been started in this manner, the operation proceeds to step ST11.

In step ST11, the control unit 2 judges whether or not the own vehicle has arrived at the destination. In step ST 11, if it is judged that the own vehicle has arrived at the destination, the operation proceeds to step ST12, and if it is judged that the own vehicle has not arrived at the destination, the control unit 2 waits until it is judged that the own vehicle has arrived at the destination. In step ST12, the control unit 2 finishes the route guidance, returns to step ST1, and repeats the above processes.

As described above, in the underlying technology, if it is judged that the own vehicle cannot travel to the destination, the pre-arrival chargeable site is added to the route to the destination and the user is informed of this, but the underlying technology does not take into account the remaining battery capacity after arrival at the destination. Therefore, the own vehicle may be incapable of traveling after arrival at the destination. Thus, this embodiment adopts the following configuration.

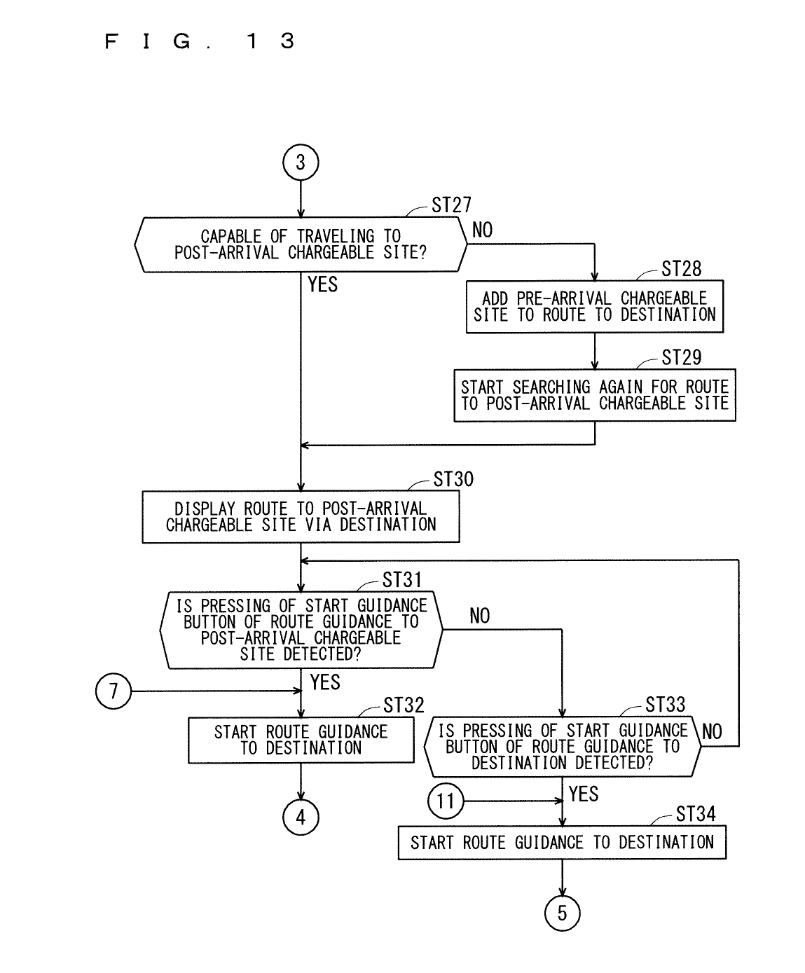

FIGS. 10 and 11 are diagrams illustrating examples of image displayed in the display screen 161 on the display 16 of the navigation device 100 in the first embodiment of the present invention. FIG. 10 is a diagram illustrating a whole route screen 300. In this embodiment, in the case where the start search button 243 is pressed in the above-described facility surroundings screen 240 illustrated in FIG. 6, the whole route screen 300 illustrated in FIG. 10 is displayed. In the whole route screen 300, a post-arrival chargeable site 301 is displayed in addition to the current position symbol 201, the destination 251, and the destination symbol 252. The post-arrival chargeable site 301 is a battery chargeable site after arrival at the destination. In the whole route screen 300, a route from the destination 251 to the post-arrival chargeable site 301 is shown by a dotted line.

Also, in addition to the current position button 253, the whole route screen 300 includes a start route-search for destination button 302 for instructing to start searching for a route to the destination 251 and a start route-search for charge site button 303 for instructing to start searching for a route to the post-arrival chargeable site 301.

FIG. 11 is a diagram illustrating a whole route screen 310. FIG. 11 illustrates the whole route screen 310 displayed in the case where the start route-search for charge site button 303 is pressed in the whole route screen 300 illustrated in FIG. 10. The whole route screen 310 includes a start guidance button 311 for instructing to start route guidance to the post-arrival chargeable site 301.

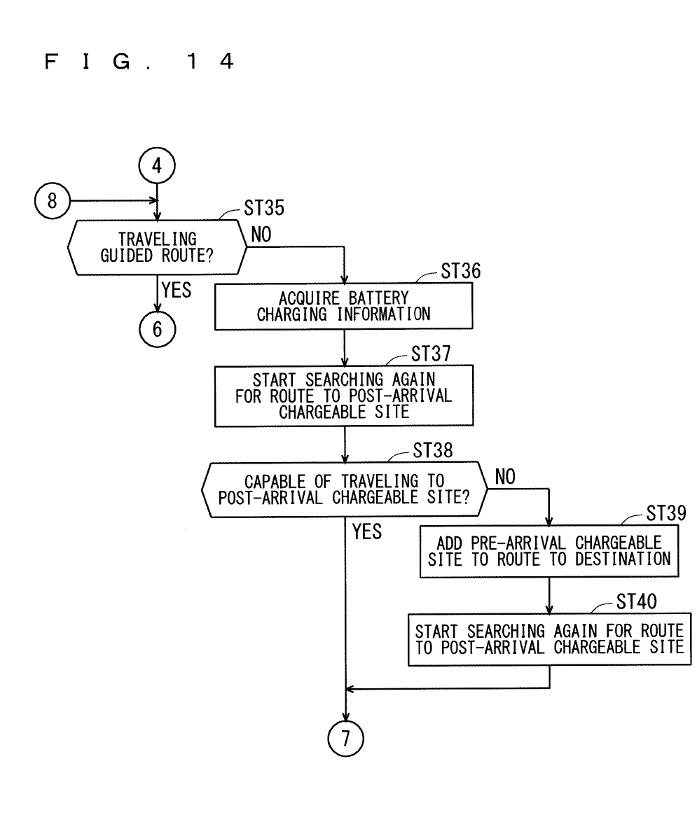

FIGS. 12 to 17 are flowcharts showing a route guidance procedure in the first embodiment of the present invention. Each process of the flowcharts shown in FIGS. 12 to 17 is performed by the control unit 2. Processing in the flowcharts shown in FIGS. 12 to 17 is started in response to power-on of the navigation device 100, and the operation proceeds to step ST21.

The processes of step ST21 to step ST23 are performed in the same manner as the above processes of step ST1 to step ST3 shown in FIG. 8. That is, in step ST21, a map covering the current position including the own vehicle is displayed on the display 16.

In step ST22, it is judged whether or not the destination is set. If it is judged that the destination is set, the operation proceeds to step ST23, and if it is judged that the destination is not set, the control unit 2 waits until it is judged that the destination is set.

In step ST23, it is judged whether or not pressing on a start route-search for destination button 302 is detected. If it is judged that the pressing is detected, the operation proceeds to step ST24, and if it is judged that the pressing is not detected, the control unit 2 waits until it is judged that the pressing is detected.

In this embodiment, in step ST24, the control unit 2 adds the post-arrival chargeable site after the user-set destination. As the post-arrival chargeable site, a site having the battery charging facility closest to the destination or a battery chargeable site which has been previously input and stored by the user, for example, is added. When the post-arrival chargeable site is added as described above, the operation proceeds to step ST25.

In step ST25, the control unit 2 acquires, as the battery charging information, the EV information such as the remaining battery capacity from information about the own vehicle provided from outside of the navigation device 100 (hereinafter, referred to as “outside vehicle information”).

Next, in step ST26, searching for a route to the post-arrival chargeable site added in step ST25 is started. When the route search has been started as described above, the operation proceeds to step ST27.

In step ST27, it is judged whether or not traveling to the post-arrival chargeable site is possible by taking into account the EV information such as the remaining battery capacity from the outside vehicle information. In step ST27, if it is judged that the own vehicle can travel to the post-arrival chargeable site, the operation proceeds to step ST30, and if it is judged that the own vehicle cannot travel to the post-arrival chargeable site, the operation proceeds to step ST28.

If it is judged in step ST27 that traveling to the post-arrival chargeable site is not possible, and the operation proceeds to step ST28, then in step ST28, the control unit 2 acquires the EV information such as a remaining battery capacity and the traveling information and, by taking these into account, adds a pre-arrival chargeable site to the route to the destination as a transit point so that the own vehicle can travel to the post-arrival chargeable site via the destination. As the pre-arrival chargeable site, a site having the battery charging facility or a battery chargeable site which has been previously input and stored by the user, for example, is selected.

In step ST29, the control unit 2 starts searching again for a route to the post-arrival chargeable site in the route which is additionally set with the pre-arrival chargeable site. Specifically, the guidance unit 13 creates the guidance information by performing the guidance processing from the current position of the own vehicle to the destination.

In step ST30, the control unit 2 displays a route to the post-arrival chargeable site via the destination on the display 16. Specifically, the control unit 2 provides the display controller 15 with the route to the destination provided from the route calculator 12 and the guidance information such as the intersection guide map to the destination provided from guidance unit 13. The display controller 15 performs the display processing on the provided route and guidance information for displaying on the display 16, provides the information to the display 16, and causes the display 16 to display the information.

In step ST31, the control unit 2 judges whether or not pressing on the start guidance button for instructing to start route guidance to the post-arrival chargeable site is detected. In step ST31, if it is judged that the pressing is detected, the operation proceeds to step ST32, and if it is judged that the pressing is not detected, the operation proceeds to step ST33.

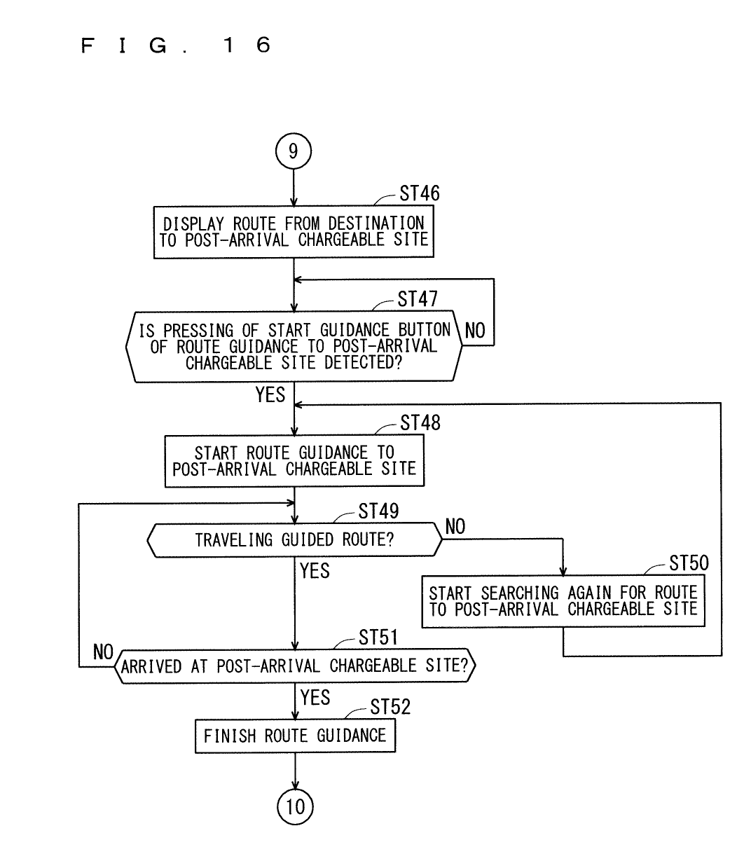

In step ST32, the control unit 2 starts the route guidance to the destination. Specifically, the control unit 2 provides the audio controller 17 with the guidance audio information out of the guidance information to the destination provided from the guidance unit 13. The audio controller 17 performs the audio processing on the provided guidance audio information for outputting from the speaker 18, provides the information to the speaker 18, and causes the speaker 18 to output the audio. In this manner, the user is guided through the route by audio. Thereafter, the guide messages corresponding to the environment which changes as the vehicle travels are output sequentially. When the route guidance to the destination is started in this manner, the operation proceeds to step ST35 shown in FIG. 14.

In the case where the operation proceeds from step ST31 to step ST33, the control unit 2 judges in step ST33 whether or not pressing on the start guidance button for instructing to start route guidance to the destination is detected. In step ST33, if it is judged that the pressing is detected, the operation proceeds to step ST34, and if it is judged that the pressing is not detected, the operation returns to step ST31.

In step ST34, as in step ST32, the control unit 2 starts the route guidance to the destination. When the route guidance to the destination is started as described above, the operation proceeds to step ST53 shown in FIG. 17.

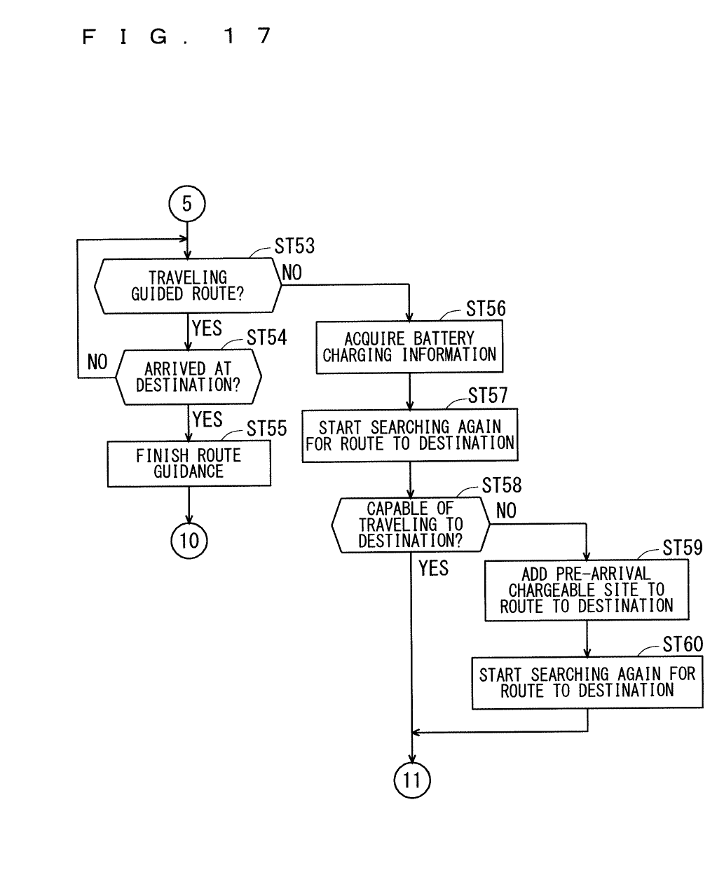

In step ST35 shown in FIG. 14, the control unit 2 judges whether or not the own vehicle is traveling the guided route. In step ST35, if it is judged that the own vehicle is traveling the guided route, the operation proceeds to step ST41 shown in FIG. 15, and if it is judged that the own vehicle is not traveling the guided route, the operation proceeds to step ST36.

In step ST36, the control unit 2 acquires the battery charging information, and the operation proceeds to step ST37.

In step ST37, the control unit 2 starts searching again for a route to the post-arrival chargeable site. When searching for a route to the post-arrival chargeable site has been started again as described above, the operation proceeds to step ST38.

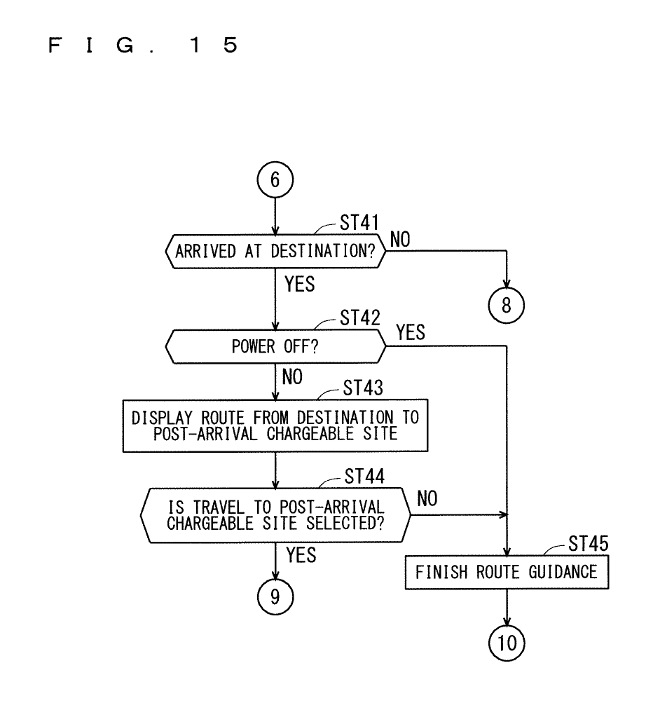

In step ST38, the control unit 2 judges whether or not the own vehicle can travel to the post-arrival chargeable site based on the battery charging information acquired in step ST36. In step ST38, if it is judged that the own vehicle can travel to the post-arrival chargeable site, the operation returns to step ST32 shown in FIG. 13, and the route guidance to the destination is started for the route searched out again in step ST37. In step ST38, if it is judged that the own vehicle cannot travel to the post-arrival chargeable site, the operation proceeds to step ST39.

In step ST39, as in the above-described step ST28 shown in FIG. 13, the control unit 2 adds a pre-arrival chargeable site to the route to the destination, and the operation proceeds to step ST40.

In step ST40, as in the above-described step ST29 shown in FIG. 13, the control unit 2 starts searching again for a route to the post-arrival chargeable site to include the pre-arrival chargeable site. When searching has been started again as described above, the operation returns to the above-described step ST32 shown in FIG. 13, and starts the route guidance to the destination for the route searched out again in step ST40.

In step ST41 shown in FIG. 15, the control unit 2 judges whether or not the own vehicle has arrived at the destination. In step ST41, if it is judged that the own vehicle has arrived at the destination, the operation proceeds to step ST42, and if it is judged that the own vehicle has not arrived at the destination, the operation returns to the above-described step ST35 shown in FIG. 14, and the above processes are repeated.

In step ST42, the control unit 2 judges whether or not power off has been instructed. In step ST42, if it is judged that the power off has not been instructed, the operation proceeds to step ST43, and if it is judged that the power off has been instructed, the operation proceeds to step ST45.

In step ST43, the control unit 2 controls the display controller 15 to display the route from the destination to the post-arrival chargeable site on the display 16, and the operation proceeds to step ST44.

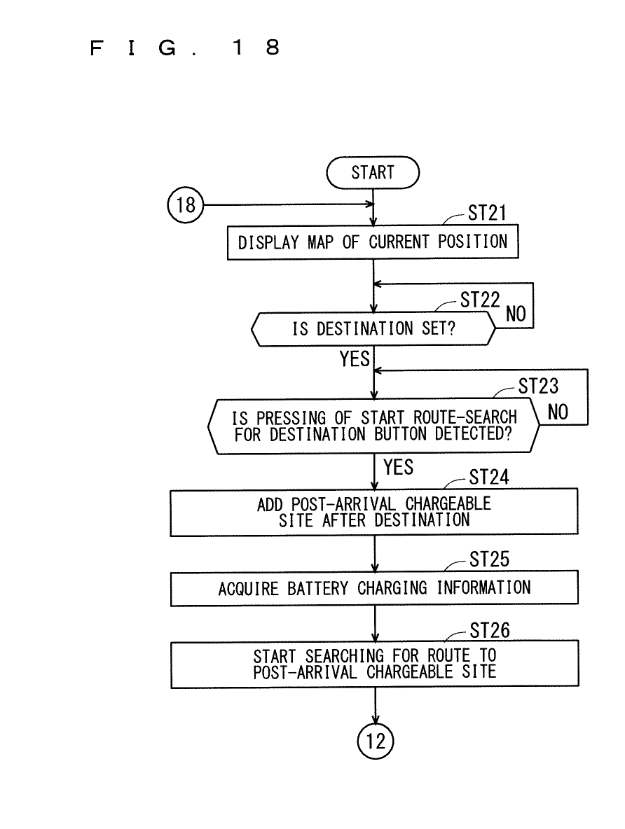

In step ST44, the control unit 2 judges whether or not travel to the post-arrival chargeable site is selected. In step ST44, if it is judged that the travel is selected, the operation proceeds to step ST46 shown in FIG. 16, and if it is judged that the travel is not selected, the operation proceeds to step ST45.

In step ST45, the control unit 2 finishes the guidance to the destination. When the guidance is finished as described above, the operation returns to step ST21 shown in FIG. 12, and the above processes are repeated.

In step ST46 shown in FIG. 16, the control unit 2 displays the route from the destination to the post-arrival chargeable site on the display 16. In this manner, the control unit 2 presents the route to the post-arrival chargeable site as the next battery chargeable site to the user, letting the user judge whether or not to travel to the post-arrival chargeable site. In the case where the user has judged to travel to the post-arrival chargeable site, the user instructs to start the route guidance to the post-arrival chargeable site by, for example, pressing the start guidance button 311 in the above-described whole route screen 310 which presents the route to the post-arrival chargeable site shown in FIG. 11.

In step ST47, the control unit 2 judges whether or not pressing on the start guidance button for instructing to start route guidance to the post-arrival chargeable site is detected. In step ST47, if it is judged that the pressing is detected, the operation proceeds to step ST48, and if it is judged that the pressing is not detected, the control unit 2 waits until it is judged that the pressing is detected.

In step ST48, the control unit 2 starts the route guidance to the post-arrival chargeable site.

In step ST49, the control unit 2 judges whether or not the own vehicle is traveling the guided route. In step ST49, if it is judged that the own vehicle is traveling the guided route, the operation proceeds to step ST51, and if it is judged that the own vehicle is not traveling the guided route, the operation proceeds to step ST50.

In step ST50, the control unit 2 starts searching again for a route to the post-arrival chargeable site. When searching has been started again as described above, the operation returns to step ST48, and the route guidance is started for the route to the post-arrival chargeable site searched out again in step ST50.

In step ST51, the control unit 2 judges whether or not the own vehicle has arrived at the post-arrival chargeable site. In step ST51, if it is judged that the own vehicle has arrived at the post-arrival chargeable site, the operation proceeds to step ST52, and if it is judged that the own vehicle has not arrived at the post-arrival chargeable site, the operation returns to step ST49, and the above processes are repeated.

In step ST52, the control unit 2 finishes the route guidance, and returns to the above-described step ST21 shown in FIG. 12, and displays the map covering the current position on the display 16. That is, the display screen 161 on the display 16 returns to the current position screen 200.

If it is judged that the pressing on the start guidance button for instructing to start route guidance to the destination is detected in the above-described step ST33 shown in FIG. 13, and the operation proceeds to step ST34 and then to step ST53 shown in FIG. 17, the control unit 2 judges in step ST53 whether or not the own vehicle is traveling the guided route. In step ST53, if it is judged that the own vehicle is traveling the guided route, the operation proceeds to step ST54, and if it is judged that the own vehicle is not traveling the guided route, the operation proceeds to step ST56.

In step ST54, the control unit 2 judges whether or not the own vehicle has arrived at the destination. In step ST54, if it is judged that the own vehicle has arrived at the destination, the operation proceeds to step ST55, and if it is judged that the own vehicle has not arrived at the destination, the operation returns to step ST53 and the above processes are repeated. In step ST55, the control unit 2 finishes the route guidance, returns to the above-described step ST21 shown in FIG. 12, and displays the map covering the current position on the display 16.

In the case where the operation proceeds from step ST53 to step ST56, the control unit 2 acquires the battery charging information in step ST56, and the operation proceeds to step ST57. In step ST57, the control unit 2 starts searching again for a route to the destination, and the operation proceeds to step ST58.

In step ST58, the control unit 2 judges whether or not the own vehicle can travel to the destination. In step ST58, if it is judged that the own vehicle can travel to the destination, the operation returns to step ST34 shown in FIG. 13, and the route guidance to the destination is continued. In step ST58, if it is judged that the own vehicle cannot travel to the destination, the operation proceeds to step ST59.

In step ST59, the control unit 2 adds a pre-arrival chargeable site to the route to the destination, and the operation proceeds to step ST60.

In step ST60, the control unit 2 starts searching again for a route to the destination to include the pre-arrival chargeable site added in step ST59. When searching has been started again as described above, the operation returns to step ST34 shown in FIG. 13, and the control unit 2 starts the route guidance for the route to the destination searched out again in step ST60.

As described above, according to this embodiment, the route calculator 12 searches for a route from the current position acquired by the current position detector 5, via the destination input by the instruction input unit 10, to the post-arrival chargeable site. As a result, the post-arrival chargeable site can be previously recognized before arriving at the destination. Therefore, measures can be previously taken, for example, to prevent the own vehicle from being incapable of traveling after arrival at the destination.

Further, according to this embodiment, the EV information input unit 19 acquires the battery charging information about the charged amount of the battery of the own vehicle. The control unit 2 judges whether or not traveling from the current position via the destination to the post-arrival chargeable site is possible based on the acquired battery charging information.

As a result, before arriving at the destination, it is possible to judge whether or not traveling from the current position via the destination to the post-arrival chargeable site is possible. Therefore, measures can be taken, for example, to ensure that the own vehicle can travel from the destination to the post-arrival chargeable site, before arriving at the destination.

Further, in this embodiment, if the control unit 2 has judged that traveling to the pre-arrival chargeable site is possible, the display controller 15 outputs to the display 16 the route from the current position via the destination to the post-arrival chargeable site searched out by the route calculator 12.

As a result, it is possible to present to the user that traveling from the current position via the destination to the post-arrival chargeable site is possible. Further, it is possible to present the post-arrival chargeable site to the user before arriving at the destination. Therefore, the user can make the own vehicle travel without being worried that the own vehicle might be incapable of traveling.

Further, in this embodiment, if the control unit 2 has judged that traveling to the post-arrival chargeable site is not possible, the route calculator 12 starts searching again for a route which includes a pre-arrival chargeable site between the current position and the destination. The display controller 15 outputs the route searched out again to the display 16.

As a result, before arriving at the destination, it is possible to present to the user that the own vehicle cannot travel to the post-arrival chargeable site. Further, before arriving at the destination, it is possible to present the pre-arrival chargeable site between the current position and the destination to the user. As a result, since the user is encouraged to charge up at the pre-arrival chargeable site, it is possible to prevent the own vehicle from not being able to travel to the post-arrival chargeable site.

Further, in this embodiment, the guidance unit 13 guides the route searched out by the route calculator 12 by using the display controller 15 and the audio controller 17. As a result, the user can be guided through the route from the current position via the destination to the post-arrival chargeable site. Therefore, user convenience can be improved.

Further, in this embodiment, since the instruction input unit 10 is configured to allow input of a candidate site for the post-arrival chargeable site, candidate sites for the post-arrival chargeable site can be input by the user. As a result, a route which includes a private facility, as the post-arrival chargeable site, such as a user's house or a house of the user's friend instead of a public facility can be searched. Therefore, user convenience can be improved.

In this embodiment described above, in step ST42 shown in FIG. 15, if it is judged that the power off has been instructed, the operation proceeds to step ST45, and the route guidance is finished without performing the route guidance from the destination to the post-arrival chargeable site.

The present invention is not limited thereto and, for example, the route guidance from the destination to the post-arrival chargeable site may be performed after the user has powered off the own vehicle and the navigation device 100 and visited the destination. In this case, after the power-off, the route to the post-arrival chargeable site is stored in a memory, for example, the information storage 7.

Then, after being powered on again, in step ST43, the route to the post-arrival chargeable site is displayed with a message asking the user to judge whether or not to travel to the post-arrival chargeable site. Then, in step ST44, if it is judged that the user has selected to travel to the post-arrival chargeable site, the operation proceeds to step ST46, and the route guidance may be started.

### Second Embodiment

A navigation device according to the second embodiment of the present invention has the same configuration as that of the navigation device 100 according to the first embodiment except for the route guidance procedure. Therefore, in the navigation device according to the second embodiment, the same reference characters are used to refer to the parts of the configuration which are the same as those of the first embodiment, and illustrations and descriptions thereof will be omitted.

In the above-described first embodiment, a route to the post-arrival chargeable site via the destination is displayed in step ST30. Then, if it is judged that the pressing on the start guidance button for instructing to start route guidance to the post-arrival chargeable site is detected in step ST31, the route guidance to the destination is performed in step ST32 to step ST40, and after it is judged that the own vehicle has arrived at the destination in step ST41, the route to the post-arrival chargeable site is displayed in step ST43. Then, if it is judged that the user has selected to travel to the post-arrival chargeable site in step ST44, the route guidance to the post-arrival chargeable site is performed in step ST46 to step ST52.

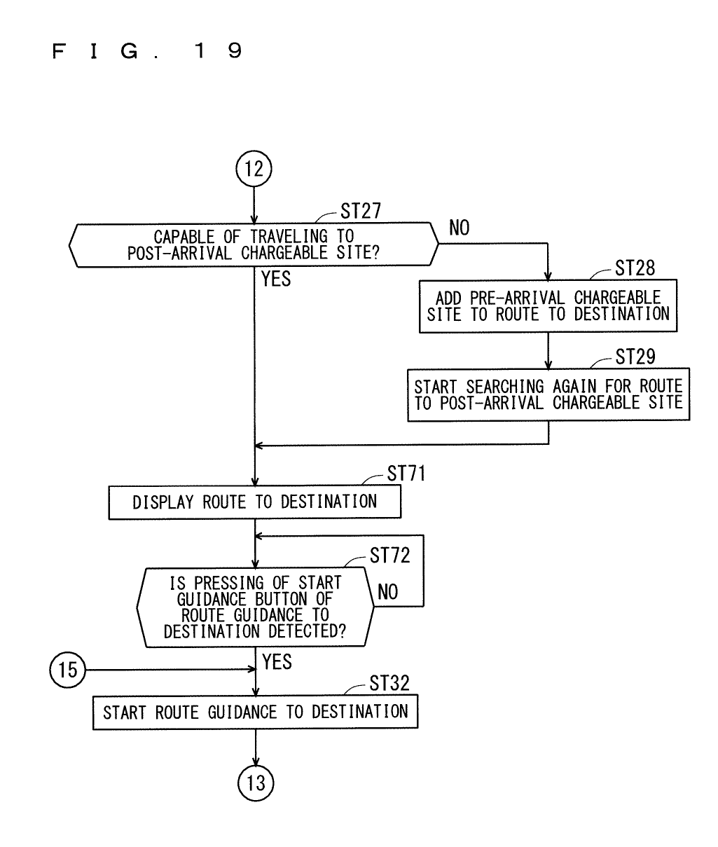

In contrast, in this embodiment, route search processing is performed as below. FIGS. 18 to 22 are flowcharts showing a route guidance procedure according to the second embodiment of the present invention. Each process of the flowcharts shown in FIGS. 18 to 22 is performed by the control unit 2. In the flowcharts shown in FIGS. 18 to 22, the same step numbers are used to refer to the same steps as those of the flowcharts shown in FIGS. 12 to 17, and descriptions thereof will be omitted. Processing in the flowcharts shown in FIGS. 18 to 22 is started in response to power-on of the navigation device 100, and the operation proceeds to step ST21.

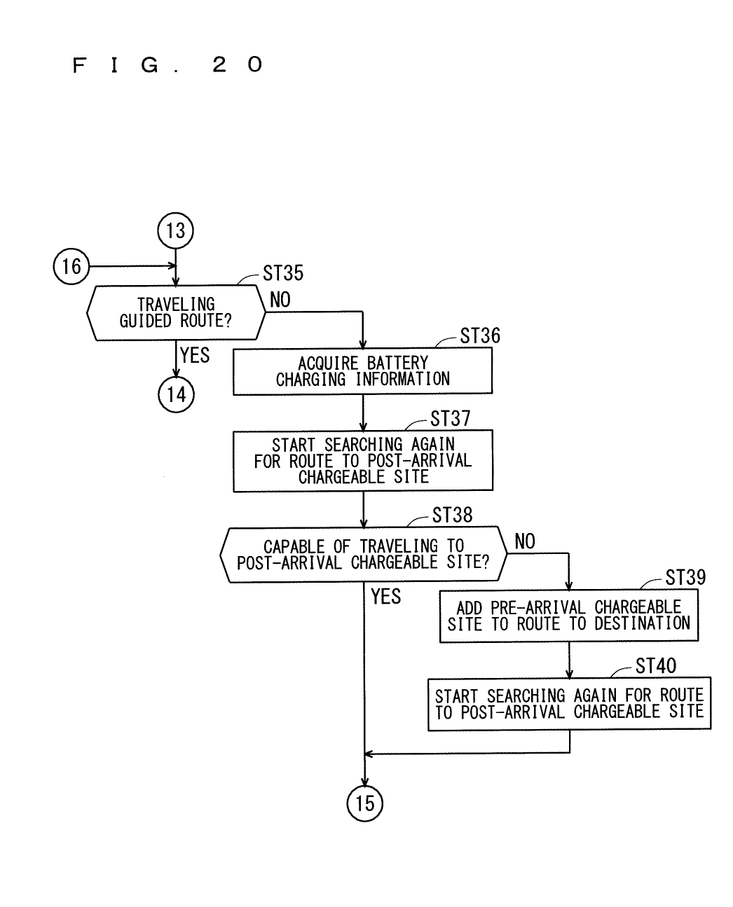

The processes of step ST21 to step ST26 are performed in the same manner as in the above-described first embodiment and the operation proceeds to step ST27 shown in FIG. 19. In this embodiment, if it is judged in step ST27 that the own vehicle can travel to the post-arrival chargeable site, the operation proceeds to step ST71, and if it is judged that the own vehicle cannot travel to the post-arrival chargeable site, the operation proceeds to step ST28. In response to completion of the processes of step ST28 and step ST29, the operation proceeds to step ST71.

In step ST71, the control unit 2 displays the route to the destination on the display 16. When the route to the destination has been displayed on the display 16 as described above, the operation proceeds to step ST72.

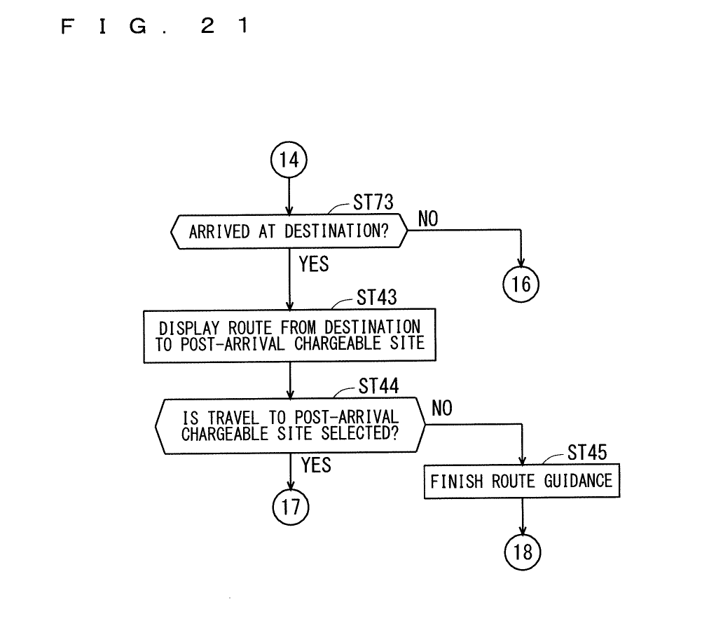

In step ST72, the control unit 2 judges whether or not pressing on the start guidance button for instructing to start route guidance to the destination is detected. In step ST72, if it is judged that the pressing is detected, the operation proceeds to step ST32, and if it is judged that the pressing is not detected, the control unit 2 waits until it is judged that the pressing is detected. Thereafter, the process of step ST32 is performed in the same manner as in the first embodiment, and the operation proceeds to step ST35 shown in FIG. 20.

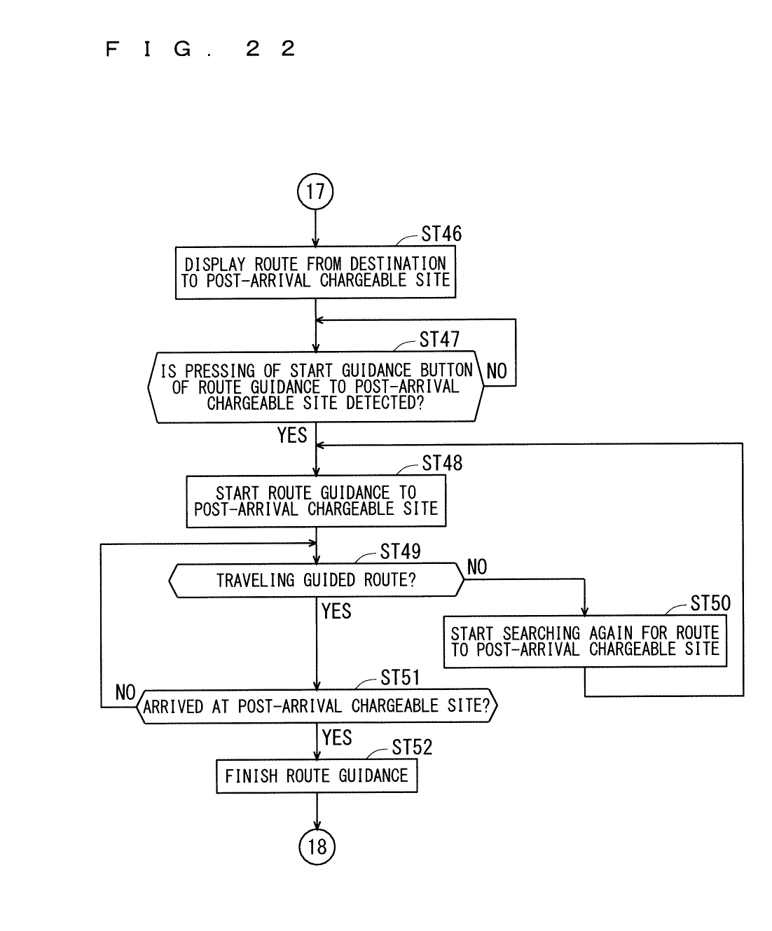

In this embodiment, in step ST35, if it is judged that the own vehicle is traveling the guided route, the operation proceeds to step ST73 shown in FIG. 21. In step ST35, if it is judged that the own vehicle is not traveling the guided route, the operation proceeds to step ST36 as in the first embodiment, and after the processes of step ST36 to step ST40 are performed, the operation proceeds to step ST32 shown in FIG. 19.

In step ST73 shown in FIG. 21, the control unit 2 judges whether or not the own vehicle has arrived at the destination. In step ST73, if it is judged that the own vehicle has arrived at the destination, the operation proceeds to step ST43, and if it is judged that the own vehicle has not arrived at the destination, the operation returns to step ST35 shown in FIG. 20, and the above processes are repeated. The processes of step ST43 and the subsequent steps are performed in the same manner as in the above-described first embodiment.

As described above, in this embodiment, firstly, the route to the destination is displayed in step ST71, and the route guidance to the destination is performed in step ST32 to step ST40. Then, after it is judged that the own vehicle has arrived at the destination in step ST73, the route to the post-arrival chargeable site is displayed in step ST43, and the route guidance to the post-arrival chargeable site is performed in step ST46 to step ST52.

As described above, the same effect as that of the above-described first embodiment can be obtained also by performing the route guidance with the route to the destination and the route to the post-arrival chargeable site sequentially displayed. For example, also in this embodiment, since the route calculator 12 searches for a route from the current position acquired by the current position detector 5, via the destination input by the instruction input unit 10, to the post-arrival chargeable site, it is possible to previously recognize the post-arrival chargeable site before arriving at the destination. Therefore, measures can be previously taken, for example, to prevent the own vehicle from being incapable of traveling after arrival at the destination.

Also, in this embodiment, the route to the post-arrival chargeable site is not displayed on the display 16 until arrival at the destination. As a result, it is not necessary to previously select whether to perform the route guidance to the destination or to the post-arrival chargeable site beforehand. Therefore, it is possible to prevent user operations from becoming complicated while preventing the own vehicle from being incapable of traveling after arrival at the destination.

In the above-described first and second embodiments, the means for performing respective representative functions in the navigation device 100 are described independently of the control unit 2. One or more types of the means for performing these respective functions such as the current position detector 5, the information update unit 8, the facility search unit 11, the route calculator 12, the guidance unit 13, the information rendering unit 14, the display controller 15, and the audio controller 17 may be included in the control unit 2. These functions may also be implemented by a microcomputer. Although the information rendering unit 14 and the display controller 15 are provided separately from each other in this embodiment, they may be integrated into one unit.

In this embodiment, the navigation device 100 is a standalone navigation device which operates based on the map information stored in the map information storage 71. The navigation device 100 is not limited thereto. The navigation device 100 may be a communication type navigation device which obtains map information of a necessary area by means of communication as required and temporarily stores the map information in an internal work memory configured by a DRAM (Dynamic Random Access Memory) or the like for use.

In this embodiment, the information storage 7 is implemented by an HDD device. The information storage 7 is not limited thereto and may be implemented, for example, by a memory device using semiconductor elements.

Further, in this embodiment, the information input unit 9 is configured to store information provided from outside by means of a medium inserted in the insertion unit 91 into the information storage 7 via the control unit 2. The information input unit 9 is not limited thereto, and may be configured to function as the information storage 7 by storing the information provided from outside into the information input unit 9. In this case, the information storage 7 may not be provided.

Also, the information input unit 9 may be configured as a connection terminal such as a USB (Universal Serial Bus). In this case, the information input unit 9 as a connection terminal and a portable medium which stores information are connected to each other directly or by wire.

The portable medium to be connected to the information input unit 9 configured as a connection terminal may be a portable music player or an electronic device equipped with that function. Further, the portable medium may be portable information and communications equipment such as a mobile phone or a portable tablet terminal. Although the portable medium and the information input unit 9 may be connected to each other by wire, they need not to be physically connected to each other, and may be configured to wirelessly exchange information. The term “wirelessly” herein means not connected by wire in contrast to the wire connection, without regard of the exchanging scheme of the information such as whether it exchanges the information by radio wave or light.

Further, the information input unit 9 may be configured to include communications equipment which exchanges information with a separately installed information center. In this case, the information input unit 9 exchanges any one of the above-described map information and AV information or the other information with the information center by using the internal communications equipment. The information input unit 9 may also use the above-described portable information and communications equipment instead of including the communications equipment.

Further, in this embodiment, the route calculator 12 is configured to present a route as the recommended route. The route calculator 12 is not limited thereto, and may be configured to present a plurality of routes as the recommended routes. All of the plurality of routes presented in this case may not necessarily be the shortest routes, but are presented within a certain allowance. The same applies to the other optional routes which are the fastest route, the low-cost route, the low-power consumption route, and the standard route.

The navigation device 100 may include the speaker 18 that outputs the guidance information separately from the speakers 18 for outputting the AV information.

In the present invention, the above-described respective embodiments can be freely combined, or optional constituent elements of the respective embodiments can be modified or omitted as required within the scope of the present invention.

Although the present invention has been described in detail, the above descriptions are examples in all aspects, and the present invention is not limited thereto. It should be understood that numerous modifications which have not been exemplified herein are possible without departing from the scope of the present invention.

### DESCRIPTION OF REFERENCE NUMERALS

1 navigation device body, 2 control unit, 3 GPS receiver, 4 self-contained navigation sensor, 5 current position detector, 6 traffic information transceiver, 7 information storage, 8 information update unit, 9 information input unit, 10 instruction input unit, 11 facility search unit, 12 route calculator, 13 guidance unit, 14 information rendering unit, 15 display controller, 16 display, 17 audio controller, 18 speaker, 19 EV information input unit, 100 navigation device.

1-6. (canceled)

7. A navigation device used in an electric vehicle, the device comprising:
a Central Processing Unit;
a memory having stored therein instructions which, when executed by the Central Processing Unit, cause the Central Processing Unit to carry out steps of:
acquiring a current position;
receiving, as an input, a destination; and
searching for a route from the acquired current position, via the destination inputted, to a post-arrival chargeable site where a battery of said electric vehicle is capable of being charged after arrival at said destination.

8. The navigation device according to claim 7, the steps further including:
acquiring battery charging information about charged amount of the battery of said electric vehicle; and
judging whether traveling from said current position via said destination to said post-arrival chargeable site is possible, based on said battery charging information.

9. The navigation device according to claim 8, the steps further including:
outputting the searched out route, wherein
when said Central Processing Unit has judged that traveling to said post-arrival chargeable site is possible, said Central Processing Unit outputs the route from said current position via said destination to said post-arrival chargeable site.

10. The navigation device according to claim 8, wherein
when said Central Processing Unit has judged that traveling to said post-arrival chargeable site is not possible, said Central Processing Unit searches again for a route including a pre-arrival chargeable site where the battery of said electric vehicle is capable of being charged between said current position and said destination, the route being from said current position, via said pre-arrival chargeable site and said destination in order, to said post-arrival chargeable site, and
when said route has been searched out again by said Central Processing Unit, said Central Processing Unit outputs the route that has been searched out again.

11. The navigation device according to claim 7, the steps further including:
guiding the route searched out by said Central Processing Unit.

12. The navigation device according to claim 7, wherein said Central Processing Unit is configured to be capable of receiving input of a candidate site for said post-arrival chargeable site.

13. A navigation method, comprising:
acquiring a current position of an electric vehicle; and
searching for a route from the acquired current position, via a destination, to a post-arrival chargeable site where a battery of said electric vehicle is capable of being charged after arrival at said destination.
